(19) United States
(12) Patent Application Publication
(10) Pub. No.: US 2003/0182132 A1
(43) Pub. Date: Sep. 25, 2003

(54) Voice-controlled arrangement and method for voice data entry and voice recognition

(76) Inventor: Meinrad Niemoeller, Holzkirchen (DE)

Correspondence Address: BELL, BOYD & LLOYD, LLC, P. O. BOX 1135, CHICAGO, IL, 60690-1135, US

(21) Appl. No.: 10/363,121

(22) PCT Filed: Aug. 16, 2001
(86) PCT No.: PCT/EP01/09475

(30) Foreign Application Priority Data
Aug. 31, 2000 (EP) 00118895.2

(51) Int. Cl. G10L 11/00

(52) U.S. Cl. 704/275

(57) ABSTRACT

The invention relates to a voice-controlled arrangement (1) comprising a plurality of devices to be controlled (3 to 9) and a mobile voice data entry unit (11) which is connected to said devices by a wireless communication link. At least some of the devices each have a device vocabulary memory (3a to 9a) and a vocabulary transmission unit (3b to 9b), and the voice data entry unit has selection means for selecting the vocabularies to he loaded according to the route destination.

The invention relates to a voice-controlled arrangement comprising a plurality of devices according to the preamble of claim 1, and to a method for inputting and recognizing a voice, which can be applied in such an arrangement.

Since voice recognition systems have increasingly developed into a standard component in powerful computers for professional and private use, including PCs and Notebooks in the medium and lower price ranges, more and more work is being carried out on the possibilities of applying such systems in devices which are used in everyday life. Electronic devices such as mobile phones, cordless phones, PDAs and remote controls for audio systems and video systems etc. usually have an input keypad which comprises at least one numerical input array and a series of functional keys.

Some of these devices—in particular of course the various kinds of telephones, but also increasingly remote controls and other devices—are increasingly equipped with microphones and possibly also headphones for inputting and outputting voice. Devices of this type (for example some types of mobile phones) in which a simple voice recognition procedure is implemented for control functions on the device itself are already known. One example of this is the voice-controlled setting up of links by a voice input of a name into a mobile phone, said name being stored in an electronic telephone directory of the telephone. Furthermore, primitive to simple voice controls are also known for other devices which are used in everyday life, for example in remote controls for audio systems or lighting systems. All known devices of this type each have a separate dedicated voice recognition system.

It is possible to envisage a development which will entail an increasing number of technical devices and systems from everyday life, in particular in the domestic sphere and in motor vehicles, being equipped with their own respective voice recognition systems. As such systems are relatively complex in terms of hardware and software, and thus expensive, if they are to provide an acceptable level of operator convenience and sufficient recognition reliability, this development is a fundamental factor which drives costs higher and is thus welcomed by consumers only to a limited degree. For this reason, the primary goal is to reduce the expenditure on hardware and software further in order to be able to make available the most cost-effective solutions possible.

Arrangements have already been proposed in which a plurality of technical devices are assigned an individual voice input unit via which various functions of these devices are controlled by voice control. The control information is preferably transmitted here in a wire-free fashion to terminals (fixed or even mobile). However, the technical problem arises here that the voice input unit has to store a very large vocabulary for the voice recognition in order to be able to control various terminals. However, handling a large vocabulary involves adverse effects on the speed and precision of the recognition processes. In addition, such an arrangement has the disadvantage that it is not readily possible to make later updates with additional devices, which may not have been envisaged when the voice input unit was implemented. Last but not least, such a solution is still always very expensive, in particular due to the high memory requirements owing to the very large vocabulary.

In a German patent application which was not published before the priority date and which originates from the applicant, a voice-controlled arrangement comprising a plurality of devices to be controlled and a mobile voice input unit which is connected to the devices via an, in particular, wire-free telecommunications link is disclosed in which a device-specific vocabulary, but no processing means for the voice recognition, are respectively provided in the individual devices of the arrangement. On the other hand, the processing components of a voice recognition system are implemented in the voice input unit (in addition to the voice input means).

At least some of the devices each have a device vocabulary memory for storing a device-specific vocabulary and a vocabulary transmission unit for transmitting the stored vocabulary to the voice input unit. In contrast, the voice input unit comprises a vocabulary reception unit for receiving the vocabulary transmitted by a device or the vocabularies transmitted by devices. If the voice input unit is placed in the spatial vicinity of one or more devices, so that a telecommunications link is set up between the voice input unit and devices, the devices transmit their vocabularies to the voice input unit which buffers them. As soon as the telecommunications link between one or more devices and the voice input unit is broken, for example if the spatial distance becomes too large, the voice input unit can reject one or more buffered vocabularies again. The voice input unit accordingly administers the vocabularies of the terminals in a dynamic fashion.

The advantage of this arrangement is principally the fact that means with a relatively small storage capacity are sufficient to store the vocabularies in the voice input unit as, owing to the spatial separation of the vocabularies from the actual voice recognition capacity, the vocabularies do not need to be continuously stored in the voice input unit. This also increases the recognition rate in the voice input unit as fewer vocabularies are to be processed. However, when there is a plurality of spatially closely adjacent devices, in particular if their transmission ranges overlap, the voice input unit may nevertheless have to store and process a large number of vocabularies or may not be able to serve all the terminals given a limited storage capacity. Particularly the latter case is inconvenient for a user as he has no influence on which vocabularies are loaded into the voice input unit by terminals and which are rejected. Even if the transmission ranges of the terminals are comparatively small—for example have diameters of only a few meters—it is possible, particularly given a concentration of a large number of different terminals in a small space as in the domestic sphere or in an office, for the user to be able to carry out voice control on only some of these terminals owing to the abovementioned problems.

The invention is therefore based on the object of proposing an arrangement of this type which in particular avoids the abovementioned problems and especially develops the selection of the terminals to be controlled by voice. The arrangement is also intended to be distinguished by low costs and an efficient method for inputting and recognizing voice.

This object is achieved by means of an arrangement having the features of patent claim 1 and by means of a method having the features of patent claim 13.

The invention develops the voice-controlled arrangement mentioned at the beginning having a plurality of devices and a mobile voice input unit connected to the devices via a wire-free telecommunications link in particular by virtue of the fact that selection means for selecting vocabularies to be loaded into the voice input unit are provided in the voice input unit. For this purpose, the selection means evaluate a directional information item of received signals which have been transmitted by the devices. The principle applied here originates from human communication: one person communicates with another by directing his attention at the person. Conversations in the surroundings of the two communicating people are “blanked out”. Other people to whom the communicating people do not direct their attention therefore also feel that they are not being addressed.

The invention ensures that only specific vocabularies are loaded by devices which have been selected by the selection means. As a result, the recognition rate is significantly improved with spatially closely adjacent terminals as, owing to the directionally dependent selection, fewer vocabularies are loaded into the voice input unit, and therefore fewer vocabularies have to be processed. For example, radio or else infrared transmission links are possible as wire-free transmission methods between the devices and the voice input unit.

The selection means preferably comprise a detector, in particular an antenna, with a directional characteristic. The directionally dependent selection takes place by orienting the detector with the devices to be controlled as the level of a received signal of a device changes with the orientation of the detector with respect to a device transmitting the signal. In the case of an infrared transmission link, the selection means comprise an infrared detector which has a limited detection range, for example by virtue of a lens placed in front of it, so that infrared signals outside the detection range do not cause a corresponding vocabulary to be loaded.

In order to be able to evaluate the level of received signals, the voice input unit preferably has a level evaluation and control device. The latter determines the level of at least one received signal and controls, as a function thereof, the loading of a vocabulary into the vocabulary buffer or buffers by means of the vocabulary reception unit, said vocabulary being transmitted by means of the signal. The level evaluation and control device is preferably designed in such a way that it does not load a vocabulary transmitted by a received signal until a specific level is exceeded.

In one preferred embodiment, a plurality of vocabularies of devices are loaded simultaneously into the voice input unit. The level evaluation and control device is expediently constructed in this embodiment in such a way that the vocabulary of a further device is loaded into the voice input unit and replaces a vocabulary loaded there as soon as the received signal of the further device exceeds a predefined level and/or the levels of the signal which transmits the vocabulary to be replaced and/or is assigned to it. A plurality of vocabularies are thus stored in the voice input unit so that even a corresponding multiplicity of devices can be controlled. However, this gives rise to a corresponding need for storage in the voice input unit.

In one development, precisely one vocabulary of a device, which is replaced by the vocabulary of another device, can then be loaded into the voice input unit as soon as a received signal of the other device exceeds a predefined level and/or the level of the signal which transmits the vocabulary to be replaced and/or is assigned thereto. Therefore, as soon as the voice input unit is directed to another device so that its transmitted signal fulfils the criteria for loading into the voice input unit, the vocabulary which has already been loaded is replaced. The advantage of this embodiment is in particular the low storage requirement in the voice input unit as only one vocabulary is ever loaded.

In the preceding embodiment, the level evaluation and control device is expediently also designed to allocate different priorities to the vocabularies loaded into the voice input unit. If a new vocabulary is loaded, the vocabulary to be replaced can be determined by reference to the priorities. A vocabulary to be loaded will usually replace the loaded vocabulary with the lowest priority. The priorities can be allocated as a function of various criteria such as for example prioritization of the devices, the frequency of control of the devices, the time for which the vocabularies remain in the voice input unit, etc. The prioritization will appropriately be allocated as a function of the frequency with which the devices are controlled, i.e. devices which are controlled very often have a higher priority than devices which, in comparison, are controlled rarely. However, the assignment of priorities preferably takes place as a function of the conditions of the levels of the signals which transmit the vocabularies and/or are assigned to them. A relatively high level brings about a higher priority than a relatively low level here.

In one particularly preferred embodiment, the level evaluation and control device generates at least one control signal which can control or influence the recognition function of the voice recognition stage, specifically as a function of the evaluated level of a received signal. The influencing or control is advantageously carried out by raising or lowering the probabilities of the occurrence of a word or a plurality of words and/or the probabilities of a boundary between words of a vocabulary which is in particular proportional to the level.

By influencing the probabilities during recognition, use is made of the fact that a plurality of terminals have the same instructions and, when such an instruction is input, the probability is used to decide which device is to be controlled. In other words, various devices can be controlled with identical instructions, which of the devices is addressed being determined by the user by the orientation of the voice input unit.

The communication between the voice input unit and the devices preferably takes place according to the Bluetooth standard. For this purpose, the vocabulary transmission unit or vocabulary transmission units and vocabulary reception unit are embodied as a radio transceiver unit according to the Bluetooth standard. The Bluetooth standard is particularly suitable for this purpose as it is provided in particular for transmitting control instructions (for example between a PC and a printer). Particularly in the present case, instructions or vocabularies are mainly exchanged between the voice input unit and the devices. Higher level transmission protocols and description standards such as, for example, WAP or XML can also be used as standards for transmitting the vocabularies in the system. In an alternative preferred embodiment, the vocabulary transmission unit or vocabulary transmission units and vocabulary reception unit may be embodied as an infrared transceiver unit.

A typical embodiment of the voice-controlled arrangement functions in such a way that, in order to carry out a directionally dependent selection of signals which are transmitted by devices, the detector is directed at specific devices so that only the signals of these devices are received. Then, the levels of the received signals are determined in the voice input unit by means of the level evaluation and control device. Depending on how the voice input unit—in the case of a radio link, the antenna with a directional characteristic—is oriented with respect to the devices, some of the received signals have a greater field strength and thus a higher level than the other signals. By reference to the specific levels of the received signals, the level evaluation and control device controls the vocabulary reception unit in such a way that only vocabularies of devices whose signals have been determined by the level evaluation and control device to be sufficient, i.e. in particular are above a predefined threshold level, are received. Even if the voice input unit, to be more precise the detector, is located in the transmission or radio range of a plurality of devices, as a result of this only the vocabularies of some of the devices are loaded. The recognition rate in the voice input unit therefore does not drop if the voice input unit is in the transmission or radio range of a large number of devices and accordingly a large number of vocabularies would be loaded if there were no directionally dependent selection according to the invention.

A vocabulary contains instruction words or phrases in orthographic or phonetic transcription and possibly additional information for the voice recognition. The vocabulary is loaded into the voice recognition system on the voice input unit after suitable conversion, specifically advantageously into a vocabulary buffer of said system, which buffer is preferably connected between the vocabulary reception unit and the voice recognition stage. The magnitude of the vocabulary buffer, which is preferably embodied as a volatile memory (for example DRAM, SRAM, etc.), is expediently adapted to the number of vocabularies to be processed or the number of devices to be controlled simultaneously. In order to make available a cheap voice input unit, a saving can be made in terms of the vocabulary buffer by configuring the selection means for evaluating and controlling levels in such a way that, for example, at most two vocabularies for controlling two devices can be loaded simultaneously into the voice input unit. It would also be conceivable to have a programmable embodiment of the selection means for evaluating levels, which means can be correspondingly set to control a plurality of devices when the vocabulary buffer is enlarged.

The selection means can have in particular an arithmetic unit which, from the level of a received signal, calculates the distance of a device transmitting the signal from the voice input unit. In addition, a threshold value corresponding to a predefined distance is stored in a threshold value memory. The calculated distance is then compared with the stored threshold value by means of a comparison device. Depending on the comparison result, in particular the vocabulary reception unit and the voice recognition stage are enabled or disabled. For this purpose, the comparison device generates a disable/enable signal. The criteria for enabling and disabling can be predefined by means of the threshold value which, for example, can also be adapted by the user by means of programming or setting operations. For example, the user could predefine that only devices at a distance of 2 m are enabled for the voice input unit. In contrast, devices further away should be disabled.

In summary, the voice-controlled arrangement according to the invention provides the advantages that

the recognition in the case of spatially close devices which compete with one another is improved,

the vocabulary to be processed in the voice input unit is optimized not only in terms of its size, but also in terms of probabilities,

the vocabularies of the various devices do not have to be matched to one another, i.e. may contain identical instructions, and

a user can control different devices with the same instructions, and merely by the orientation of the voice input unit a user can determine which of the devices is to be addressed.

By using directionally dependent information of received signals, the overall vocabulary which is to be stored in the voice input unit can be kept at a low level overall. As a result, the voice modeling of the voice recognition stage can also be optimized. At the same time, the problem of the possible overlapping of vocabularies is solved. The arrangement according to the invention can advantageously be used in wire-free telecommunications links with a short range, for example in Bluetooth systems or else infrared systems.

Advantages and expedient aspects of the invention also emerge from the dependent claims and the following description of a preferred exemplary embodiment by reference to the drawing, in which

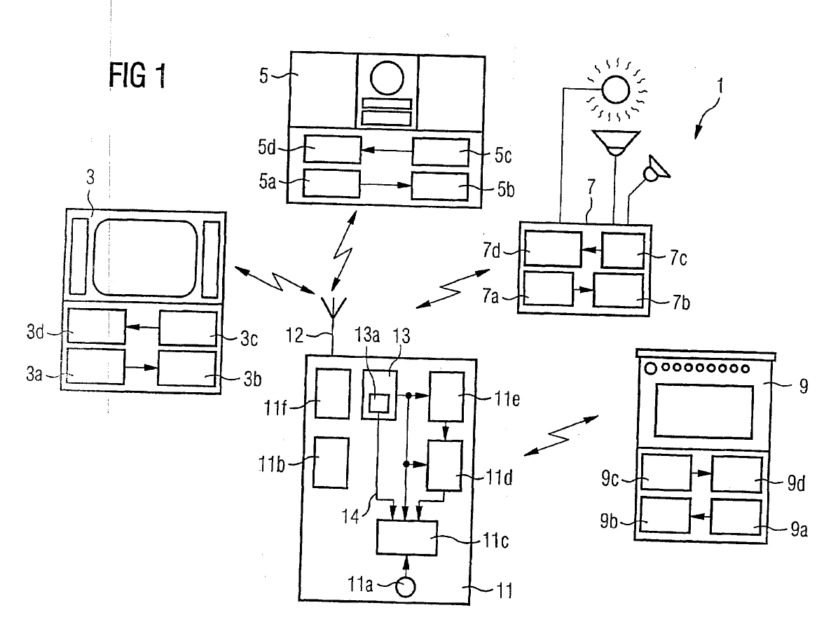

FIG. 1 shows a sketch-like functional block diagram of a device configuration composed of a plurality of voice-controlled devices, and

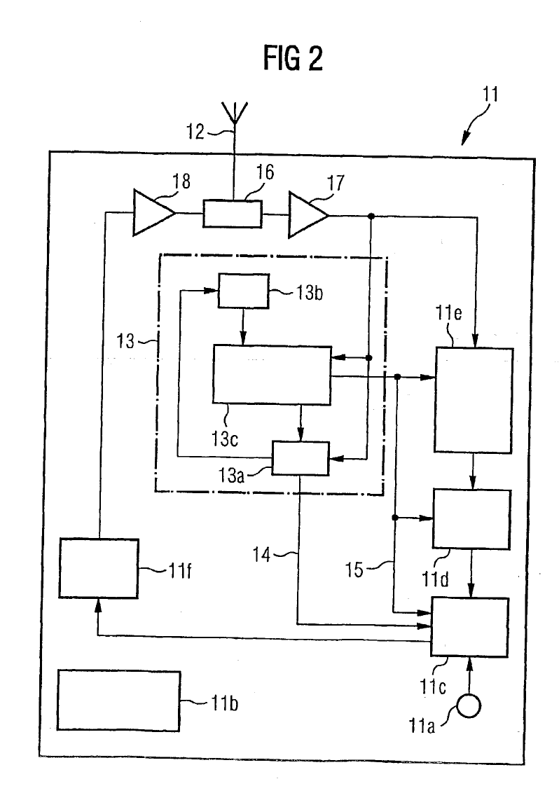

FIG. 2 shows a functional block diagram of an exemplary embodiment of a voice input unit.

The device configuration 1 shown in FIG. 1 in a sketch-like functional block diagram comprises a plurality of voice-controlled devices, specifically a television set 3, an audio system 5, a lighting unit 7 and a cooker hob 9 with a voice input unit 11 (referred to below as mobile voice control terminal).

The devices 3 to 9 to be controlled each have a device vocabulary memory 3a to 9a, a vocabulary transmission unit 3b to 9b operating according to the Bluetooth standard, a control instruction reception unit 3c to 9c and a microcontroller 3d to 9c.

The mobile voice control terminal 11 has a voice transmitter 11a, a display unit 11b, a voice recognition stage 11c which is connected to the voice transmitter 11a and to which a vocabulary buffer 11d is assigned, a vocabulary reception unit 11e, a control instruction transmission unit 11a, an antenna 12 with directional characteristics and a level evaluation and control device 13.

The various transmission and reception units of the devices 3 to 9 and of the voice control terminal 11 are embodied—in a manner known per se—such that their range is matched to the character of the device and to the customary spatial relations between the device and user—for example the range of the vocabulary transmission unit 9b of the cooker hob 9 is significantly smaller than that of the vocabulary transmission unit 7b of the illumination control unit 7.

In the vocabulary buffer 11d of the voice control terminal 11, it is possible to implement a basic vocabulary of control instructions and additional terms which ensures that the entire system and specific emergency or protection functions are activated in every situation of use. The device vocabulary memories contain special vocabularies for controlling the respective device. After their transmission, the voice recognition stage 11c can access them and the user can utter control instructions for the respective device. These instructions are transmitted by the control instruction transmission unit 11f of the voice control terminal 11 to the control instruction reception units 3c to 9c and converted into control signals by the respective microcontroller 3d to 9d of the devices 3 to 9.

If the voice control terminal 11 is located in the radio area of the devices 3 to 9, i.e. there are wire-free telecommunications links between the voice control terminal 11 and the devices 3 to 9, the devices 3d to 9d transmit their vocabularies from the respective device vocabulary memories 3a to 9a to the voice control terminal 11. The latter receives the corresponding signals via its antenna 12 which has a directional characteristic so that the field strength of the signals transmitted by the devices 3 and 5, toward which the voice control terminal 11, in particular its antenna 12, is directed, is greater than the field strength of the signals transmitted by the devices 7 and 9.

The level evaluation and control device 13 determines the level from the field strength of all the received signals by means of an amplitude measurement of the output signals corresponding to the received signals at an antenna booster connected downstream of the antenna 12. The corresponding digitized output signals can then be further processed by means of a microcontroller in the voice control terminal 11. Which of the vocabularies corresponding to the signals are to be loaded into the vocabulary buffer 11d via the vocabulary reception unit 11e is calculated by an arithmetic unit 13a of the level evaluation and control device from the output signals of the antenna booster.

In the present case, the arithmetic unit 13a determines that the field strength of the signals received by the devices 3 and 5 is greater than the field strength of the signals received by the devices 7 and 9, and consequently controls the vocabulary reception unit 11e and the vocabulary buffer 11d in such a way that the vocabularies of the devices 3 and 5 are received and loaded. In addition, the level evaluation and control device 13 controls the voice recognition stage 11c so that the latter interprets the received vocabularies. The field strength of the received signals of the devices 3 to 9 is continuously measured. By reference to the measurement results, the arithmetic unit 13a of the level evaluation and control device 13 determines a control signal 14 which is transmitted to the voice recognition stage 11c and raises the probabilities of the occurrence of one word or a plurality of words and/or probabilities of boundaries between words of the respective vocabulary (if the field strength of the received signal increases) in proportion to the measured field strength of a reception signal, or reduces them (if the field strength of the received signal decreases). The voice recognition rate is thus influenced by means of the control signal 14 through the orientation of the voice control terminal 11 with respect to the devices 3 to 9.

If the voice control terminal 11 is directed at the cooker hob 9, the level evaluation and control device 13 determines an increase in the field strength of the signal which has been transmitted by the cooker hob 9, and it decides firstly whether the vocabulary of the cooker hob 9 is received and loaded into the vocabulary buffer 11d via the vocabulary reception unit 11e. At the same time, the level evaluation and control device 13 decides which of the vocabularies already stored in the vocabulary buffer 11d is to be rejected. This is usually the vocabulary of the device which transmits the signal with the lowest field strength or whose signal is no longer received at all.

FIG. 2 shows, by means of a functional block circuit diagram, the internal structure of the voice control terminal 11 and in particular the wiring of the essential function blocks.

A signal which is received via the antenna 12 with a directional characteristic is fed to a transceiver 16, downstream of which on the one hand a reception amplifier 17 and on the other hand the vocabulary reception unit 11e are connected. A signal which is received via the antenna 12 and conditioned by the transceiver 16 is fed to the level evaluation and control device 13. Owing to the directional characteristic of the antenna, only signals which 11e in the “directed” reception region of the antenna are received. A subset of signals which lie in the reception range of the antenna is thus selected from a multiplicity of signals by means of the antenna. The level evaluation and control device 13 comprises the arithmetic unit 13a, a comparison device 13c as well as a threshold value memory 13b. From the field strength of the received signal, the arithmetic unit 13a calculates the distance from a device transmitting the signal. The supplied signal is then compared, by means of the comparison device 13c, with a (threshold) value which is stored in the threshold value memory 13b and corresponds to a predefined distance. As a result, the signals which are received via the antenna are selected once more as a function of the distance of their sources.

Depending on the comparison, at least one disable/enable signal 15 is formed which is fed to the vocabulary reception unit 11e, to the vocabulary buffer 11d and to the voice recognition stage 11c and disables or enables it. It is enabled if the signal fed to the level evaluation and control device 13 is above the value stored in the threshold value memory 13b, and otherwise disabling takes place. If the abovementioned units are disabled, the vocabulary of the device which has sent the signal cannot be loaded. In this case, the device is outside the range for voice control or the reception range covered by the antenna 12.

The arithmetic unit 13a is also used to generate the threshold value. For this purpose, the signal at the output of the reception amplifier 11 is fed to the arithmetic unit 13a. The latter can compare the supplied signal internally with the calculated and current threshold value, and if appropriate form a new threshold value from the signal and store said threshold value in the threshold value memory 13b. The direct feeding of the signal also serves to generate a control signal 14 which is used by the voice recognition stage for setting the voice recognition. Depending on the field strength of a received signal, the arithmetic unit 13a calculates how the probabilities of the occurrence of a word or a plurality of words and/or probabilities of boundaries between words are to be influenced.

The following description of a typical constellation will serve for explanatory purposes: a subscriber moves away from a device which is to be controlled and whose vocabulary is loaded into the voice control terminal 11, or swivels the voice control terminal 11 in such a way that the signal transmitted by the device is received more weakly by the antenna with a directional characteristic. As a whole, the reception field strength of the signal which is output by the device is reduced at the voice control terminal 11. The signal is however still received via the antenna 12 and fed to the arithmetic unit 13a via the transceiver 16 and the reception amplifier 17. Said arithmetic unit 13a calculates, for example, the field strength from the signal level and detects that said field strength is weaker than before (but larger than the threshold value as otherwise the corresponding vocabulary would be removed from the vocabulary buffer in favor of another vocabulary). From the difference between the current field strength and the previous field strength, the arithmetic unit 13a then calculates the control signal 14 which reduces, in the voice recognition stage, the probabilities of the occurrence of a word or a plurality of words and/or probabilities of boundaries between words of the vocabulary of the device in proportion to the difference (conversely there can also be a rise if the field strength has become greater).

A particularly advantageous implementation of the voice control terminal takes the form of a mobile phone whose voice input facility and-computing power can be used, at least in modern devices, perfectly well for the voice control of other devices. In a mobile phone, there are usually already a level evaluation and control device or field strength measuring device and analog/digital converter for digitizing the antenna output signals so that only the selection means for voice recognition still have to be implemented. Modern mobile phones are additionally equipped with very powerful microcontrollers (usually 32-bit microcontrollers) which are used to control the user interface such as the display unit 11b, the keypad, telephone directory functions etc. Such a microcontroller can at least partially also perform voice recognition functions or at least the functions of the arithmetic unit 13a of the level evaluation and control device 13 as well as of the entire control of the enabling and disabling of the vocabulary reception unit 11e, the vocabulary buffer 11d and the voice recognition stage 11c as well as the generation of the control signal 14.

Apart from mobile phones, of course cordless phones are advantageously also suitable as a voice input unit, in particular cordless phones according to the DECT standard. Here, the DECT standard itself can be used for communication with the controlling devices. A particularly convenient embodiment of the voice input terminal is obtained—in particular for specific professional applications but possibly also in the domestic sphere and in motor vehicles—with the embodiment of the voice input unit as a microphone headset.

The application of the proposed solution in a user scenario will be briefly outlined below:

A user is driving his car home from the office. In the car, he selects a desired station on his car radio using the hands-free device of his mobile phone by uttering the name of a station. In this case, the mobile phone which is used as a voice input terminal is directed only at one device, specifically the car radio.

When he arrives at the garage, the mobile phone enters the radio range of a garage door controller and loads the vocabulary transmitted by said controller into its vocabulary buffer. The user can then open the garage door by means of voice inputting of the instruction “open the garage”. After the user has switched off the car and closed the garage by uttering the respective control instruction, he takes the mobile phone, goes to the front door of the house and directs the mobile phone at a front door opening system. After the vocabulary of the front door opening system has been loaded into the mobile phone, the user can speak the control instruction “open door” into the voice recognition system in the mobile phone, causing the door to open.

When he enters a living room, the mobile phone enters the radio range of a television, an audio system and a lighting system. The user directs the mobile phone firstly at the lighting system so that the vocabulary from this system is loaded into the mobile phone, the vocabularies of the car radio and of the garage door opening system which are now superfluous being discarded. After the vocabulary of the lighting system has been loaded, the user can control it by voice inputting respective commands.

In order to be able to use the television, the user then directs the mobile phone at the television which is located in the direct vicinity of the audio system. The mobile phone is therefore in the radio range both of the television and of the audio system and receives two signals, namely one from the television and one from the audio system. The signal of the lighting system is weaker in comparison to the two aforementioned signals so that only the vocabularies of the television and of the audio system are loaded into the mobile phone. The user can thus control both the television and the audio system.

If the user wishes to reduce the brightness of the light somewhat when watching television, he must firstly point the mobile phone again in the direction of the lighting system so that the respective vocabulary is loaded into the mobile phone. The loading of a vocabulary depends on the size of the vocabulary, but owing to the only small number of necessary control commands for the television, audio system, lighting system or a cooker, takes only fractions of seconds. The loading of a vocabulary can be indicated for example in the display of the mobile phone. After the vocabulary has been loaded into the mobile phone, this can be indicated for example by a short signal tone, an LED display which switches over for example from red to green. As soon as the user is informed that the vocabulary is loaded, he can control the lighting system by voice. In order to control the television or the audio system, the user must point the mobile phone at these devices. The television and audio system usually have at least to a certain extent the same instructions (for example for setting the tone and the volume). Depending on the direction in which the user then points the mobile phone, that is to say more in the direction of the television or more in the direction of the audio system, the measured field strength of the signals of the television and of the audio system will be used to determine with which probability the user wishes to control which device. If the user utters, for example, the instruction “increase volume” into the mobile phone and points it more in the direction of the television than in the direction of the audio system, the mobile phone antenna with a directional characteristic will cause a higher field strength of the signal of the television to be measured than that of the signal of the audio system, and the instruction “increase volume” will be accordingly assigned to the television.

The embodiment of the invention is not restricted to the above-described examples and applications but rather is likewise possible in a multiplicity of refinements which lie within the scope of activity of the person skilled in the art.

1. A voice-controlled arrangement (1) comprising a plurality of devices (3 to 9) to be controlled and a mobile voice input unit (11) which is connected to the devices via a wire-free telecommunications link, at least some of the devices each having a device vocabulary memory (3a to 9a) for storing a device-specific vocabulary and a vocabulary transmission unit (3b to 9b) for transmitting the stored vocabulary to the voice input unit, and the voice input unit having a vocabulary reception unit (11e) for receiving the vocabulary transmitted by the device or the vocabularies transmitted by the devices, voice inputting means (11a), a voice recognition stage (11c) connected to the voice inputting means and at least indirectly to the vocabulary reception unit, as well as at least one vocabulary buffer (11d) which is connected between the vocabulary reception unit (11e) and the voice recognition stage (11c) and in which loaded vocabularies are stored, characterized in that selection means (12, 13, 13a-13c) for selecting vocabularies to be loaded into the vocabulary buffer or buffers (11d), as a function of a direction information item of received signals transmitted by the devices, are provided in the voice input unit (11).

2. The voice-controlled arrangement as claimed in claim 1, characterized in that the selection means comprise a detector, in particular an antenna (12), which has a directional characteristic and which detects a level of a signal as a function of its orientation with respect to a device transmitting the signal.

3. The voice-controlled arrangement as claimed in claim 1 or 2, characterized in that the selection means comprise a level evaluation and control device (13) which determines the level of at least one received signal and controls the vocabulary reception unit (11e) and/or the vocabulary buffer or buffers (11d) and/or the voice recognition stage (11c) as a function thereof, in particular executes the loading and storage of a vocabulary.

4. The voice-controlled arrangement as claimed in claim 3, characterized in that the level evaluation and control device (13) is designed in such a way that a vocabulary transmitted by a received signal is loaded when a specific level is exceeded.

5. The voice-controlled arrangement as claimed in claim 4, characterized in that a plurality of vocabularies of devices are loaded simultaneously and the level evaluation and control device (13) is designed in such a way that the vocabulary of a further device is loaded into the voice input unit and replaces a vocabulary loaded there as soon as the received signal of the further device exceeds a predefined level and/or the level of the signal which transmits the vocabulary to be replaced and/or is assigned thereto.

6. The voice-controlled arrangement as claimed in claim 5, characterized in that precisely one vocabulary of a device is loaded and the level evaluation and control device (13) is designed in such a way that the loaded vocabulary is replaced by the vocabulary of a further device as soon as a received signal of the further device exceeds the predefined level and/or the level of the signal which transmits the vocabulary to be replaced and/or is assigned thereto.

7. The voice-controlled arrangement as claimed in one of claims 3 to 6, characterized in that the level evaluation and control device (13) is designed to assign different priorities to the vocabularies loaded into the voice input unit (11), the assignment of priorities taking place as a function of the conditions of the levels of the signals which transmit the vocabularies and/or are assigned thereto in such a way that a relatively high level brings about a higher priority than a relatively low level.

8. The voice-controlled arrangement as claimed in one of claims 3 to 7, characterized in that the level evaluation and control device (13) is designed to generate at least one control signal (14) which is formed as a function of the evaluated level of at least one received signal of a device and controls the recognition function of the voice recognition stage (11c) in such a way that probabilities of the occurrence of a word or a plurality of words and/or probabilities of a boundary between words of the vocabulary which is assigned to the device and loaded are raised or lowered, in particular in proportion to the level.

9. The voice-controlled arrangement as claimed in one of the preceding claims, characterized in that the vocabulary transmission unit or vocabulary transmission units (3b to 9b) and the vocabulary reception unit (11e) are embodied as a radio transceiver unit, in particular according to the Bluetooth standard.

10. The voice-controlled arrangement as claimed in one of claims 1 to 8, characterized in that the vocabulary transmission unit or vocabulary transmission units (3b to 9b) and the vocabulary reception unit (11e) are embodied as an infrared transceiver unit.

11. The voice-controlled arrangement as claimed in one of the preceding claims, characterized in that essentially control instructions for the respective device (3 to 9) and an accompanying vocabulary to the latter are stored in the device vocabulary memories (3a to 9a).

12. The voice-controlled arrangement as claimed in one of the preceding claims, characterized in that at least some of the devices (3 to 9) are embodied as fixed devices.

13. A method for inputting and recognizing a voice, in particular in an arrangement as claimed in one of the preceding claims, device-specific vocabularies being stored in a decentralized fashion and voice being input and recognized centrally, at least one vocabulary which is stored in a decentralized fashion being transferred in advance to the voice recognition location by means of a wire-free telecommunications link, characterized in that the transmitted vocabulary or vocabularies is/are stored and used at the voice recognition location as a function of the evaluation of the directional information of a signal transmitting the vocabulary or signals transmitting the vocabularies.

14. The method as claimed in claim 13, characterized in that the transmitted vocabulary or vocabularies is/are stored and used at the voice recognition location as a function of the evaluation of the level of a signal transmitting the vocabulary or signals transmitting the vocabularies.

15. The method as claimed in claim 14, characterized in that a plurality of vocabularies are loaded simultaneously by devices, and the vocabulary of a further device is loaded into the voice input unit and replaces a vocabulary loaded there as soon as the received signal of the further device exceeds a predefined level and/or the level of the signal which transmits the vocabulary to be replaced or is assigned thereto.

16. The method as claimed in claim 15, characterized in that precisely one vocabulary of a device is loaded and the loaded vocabulary is replaced by the vocabulary of a further device as soon as a received signal of the further device exceeds the predefined level and/or the level of the signal which transmits the vocabulary to be replaced or is assigned thereto.

17. The method as claimed in one of claims 13 to 16, characterized in that different priorities are assigned to the vocabularies loaded into the voice input unit (11), the assignment of priorities taking place as a function of the conditions of the levels of the signals transmitting the vocabularies in such a way that a relatively high level brings about a higher priority than a relatively low level.

18. The method as claimed in one of claims 13 to 17, characterized in that at least one control signal (14) is formed as a function of the evaluated level of at least one received signal of a device and controls the recognition function of the voice recognition stage (11c) in such a way that probabilities of the occurrence of a word or a plurality of words and/or probabilities of a boundary between words of the vocabulary which is assigned to the device and loaded are raised or lowered, in particular in proportion to the level.
